(19) United States
(12) Patent Application Publication
(10) Pub. No.: US 2015/0177183 A1
(43) Pub. Date: Jun. 25, 2015

(54) REVERSIBLE DETECTION OF IONS WITH PERMSELECTIVE MEMBRANES

(71) Applicant: UNIVERSITE DE GENEVE, Genève (CH)

(72) Inventors: Eric Bakker, Nyon (CH); Gaston Crespo, Barcelona (ES); Majid G. Afshar, Alborz (IR)

(73) Assignee: UNIVERSITE DE GENEVE, Genève (CH)

(21) Appl. No.: 14/415,639

(22) PCT Filed: Jul. 25, 2013
(86) PCT No.: PCT/IB2013/056095

§ 371 Date: Jan. 19, 2015

Related U.S. Application Data
(60) Provisional application No. 61/675,561, filed on Jul. 25, 2012.

(51) Int. Cl. G01N 27/333

(52) U.S. Cl. CPC G01N 27/3335

(57) ABSTRACT

The present invention relates to an electrochemical method using a permselective membrane for detection of ions in a sample. The permselective electrode includes a lipophilic reagent such as a neutral ionophore or an ion exchanger and a lipophilic ion, the lipophilic reagent being in molar excess relative to the lipophilic ion. The present invention further relates to electrode and electrochemical cell apparatus containing said permselective membrane. The permselective electrode can be used for dynamic electrochemical measurements such as chronopotentiometry.

### FIELD OF THE INVENTION

The present invention relates to an electrochemical method using a permselective membrane for detection of ions in a sample. The present invention further relates to electrode and electrochemical cell apparatus containing said permselective membrane.

### BACKGROUND OF THE INVENTION

Heparin is used as an anticoagulant in major surgical and extracorporeal procedures, such as open-heart surgery, bypass surgery, and dialysis. The use of excess heparin in medical procedures can be detrimental, however, necessitating precise monitoring of heparin administration. Real-time monitoring of heparin concentration in blood is particularly useful for preventing the risk of excessive bleeding during operations and reducing postoperative complications. Protamine is widely used antidote to counteract the anticoagulant effect of heparin. Excess use of protamine, however, can also be detrimental. For example, the use of protamine frequently results in adverse hemodynamic and hematologic side effects, such as hypertension, depressed oxygen consumption, thrombocytopenia with pulmonary platelet sequestration, and leukopenia. It is therefore also useful to be able to accurately detect and measure protamine concentration in a physiological sample, such as blood. Reliable detection of protamine allows for careful administration of the agent, thereby avoiding the associated problems noted above.

Different approaches have been proposed to determine heparin levels in blood samples. Activated clotting time measurement (ACT) is a common method for estimating the heparin concentration in whole blood. Although this method is widely used in clinical laboratories, it is nonspecific and indirect, and the results can be affected by many variables. Another approach to determine heparin levels in blood samples consists in protamine titration. Indeed, with the ability to detect protamine via ion-selective electrodes, it is also possible to determine the heparin concentration in a sample via titration of the sample with protamine. This is possible due to the specific heparin-protamine interactions. These membrane electrodes functioned on the basis of spontaneous ion-exchange processes with the negatively charged active membrane ingredient, dinonylnapthalene sulfonic acid (DNNS). Unfortunately, the high polyion charge made these sensors operationally irreversible and the single use nature of these sensors made them difficult to be established in clinical practice.

In another approach (WO 2005/008232 A1, Auburn University), a controlled current chronopotentiometric principle was introduced to make these ion-selective electrodes operationally reversible. These membranes were formulated to suppress spontaneous extraction of protamine into the membrane by using a carefully matched salt of the active ingredient dinonylnapthalene sulfonate and a tetradodecylammonium counterion. An applied current defined the flux of protamine from the sample into the membrane, while this flux was maintained at the back side of the membrane by the concomitant extraction of an ion of opposite charge. This methodology rendered the sensors operationally reversible, and gave, in complete analogy to their potentiometric counterparts, a sigmoidal calibration curve that was dependent on the nature and concentration of the background electrolyte. This methodology can be regarded as a reversible endpoint detector for heparin-protamine titration. More recently, it was found that the same type of constant current experiment may also be analyzed by chronopotentiometry. The applied current imposes a constant cation flux in direction of the membrane, which can only be maintained by protamine up to a critical time, after which local depletion occurs that results in a potential change. While this methodology is conceptually very attractive, it was thus far not possible to apply it to the detection of protamine under physiological conditions since the observed potential changes were not sufficiently large.

Therefore, there is still a need to develop method for analyte ion detection and concentration measurement in a sample that is fully reversible, wherein such reversal can be performed quickly, repeatedly, and without removing the sensor to a separate solution.

### SUMMARY OF THE INVENTION

To solve the above-identified problem, Applicants found out that it is better not to block the spontaneous extraction of analyte ion into the membrane and designed a specific permselective membrane. Thus the present invention provides a permselective membrane for use for example in an electrochemical cell. Further, the permselective membrane can be an integral part of an electrochemical cell electrode. The permselective membrane and the membrane electrode can be used in a reversible method of measuring the concentration of an analyte ion in a sample solution.

Specifically the present invention relates to a permselective membrane for reversible detection of an analyte ion in a sample, said membrane comprising
a lipophilic reagent for the detection of said analyte ion by dynamic electrochemistry, wherein said lipophilic reagent is either an electrically neutral ionophore or an ion-exchanger, and
a lipophilic ion, wherein said lipophilic ion is either of the opposite electric charge sign as said analyte ion in case an electrically neutral ionophore is present in the permselective membrane or of the same electric charge sign as said analyte ion in case an ion-exchanger is present in the permselective membrane,
wherein said lipophilic reagent is in excess of said lipophilic ion and wherein said lipophilic reagent is selective for said analyte ion.

The present invention further relates to a permselective membrane electrode comprising a housing; a reference solution contained within said housing; an electrode operatively positioned within said housing so as to be in contact with said reference solution; and the permselective membrane according to the present invention disposed at one end of said housing and in contact with said reference solution within said housing, and being operatively positioned for contacting a sample solution external to said housing.

The present invention also relates to a method of measuring the concentration of an analyte ion in a sample solution, comprising:
providing a sample solution comprising said analyte ion and a background electrolyte;
contacting said sample solution with the permselective membrane electrode according to the present invention for a sufficient period of time in order to allow spontaneous extraction of said analyte ion from the sample solution into the membrane;
contacting the sample with a reference electrode, wherein the permselective membrane electrode and the reference electrode are electrically connected;
applying an external current pulse of fixed duration to a circuit comprising the membrane electrode and the sample solution, thereby driving transport of said analyte ion from the sample solution into the membrane;
measuring a potentiometric response during the current pulse between the membrane electrode and the reference electrode; and
calculating the concentration of said analyte ion as a function of the potentiometric response.

The present invention also relates to an electrochemical cell apparatus comprising i) a permselective membrane electrode according to the present invention; ii) a reference electrode electrically connected to said membrane electrode; and iii) an electrochemical instrument operatively connected to said membrane electrode and said reference electrode.

### BRIEF DESCRIPTION OF THE FIGURES

FIG. 1 shows schematic illustration of the protamine sensing mechanism proposed here. Top: The polypropylene based sensing membrane contains DNNS, TDDA and protamine (Pⁿ⁺) bound to excess DNNS. The protamine concentration in the membrane before electrochemical perturbation is denoted with a dotted line. For the same situation, the protamine concentration in the aqueous phase (C_{P}ⁿ⁺_{(bulk)}) is close to that in the phase boundary (C_{P}ⁿ⁺_{(bp)}). Bottom: An applied current provokes a defined protamine flux across the permselective membrane. This flux is described by fickian diffusion and can be sustained up to a transition time τ. At this time protamine is depleted at the sample side of the phase boundary and results in an observed potential change. The accumulation of protamine at the left side of the membrane during the pulse is stabilized by ion-pair interaction with DNNS⁻ from the added salt DNNS-TDDA, while the liberated TDDA⁺ migrates to the right side of the membrane to stabilize excess DNNS⁻.

FIG. 2 shows A) observed time derivates of the chronpotentiometric responses on successively increasing the final protamine concentration from 0 to 90 mg L⁻¹ under physiological conditions (0.1 M NaCl, Tris pH 7.4. B) time derivative potential response to subsequent heparin additions (0-60 mg L⁻¹ final concentrations) to 90 mg L⁻¹ protamine in 0.1 M NaCl pH 7.4). C and D): observed linear calibration curve of the square root of the transition time i as a function for the data shown in a) and b), respectively. The ratio of the two slopes gives a protamine-heparin binding stoichiometry of 1.4:1 in units of mg.

FIG. 3 shows observed potential time derivates for in undiluted whole blood samples (human blood bag) upon successively increasing the final protamine concentration at the indicated levels a) in the absence of heparin and b) in the presence of 60 mg L⁻¹ heparin. C) Corresponding linear response of square root of transition times vs. protamine concentration for a) and b), respectively. The bound protamine level, and therefore the heparin concentration, is quantitatively obtained from the horizontal distance between the two dose response curves (85 mg L⁻¹).

FIG. 4 shows potentiometric measurements for two different conditioning processes are shown here: 1) corresponds to a fresh membrane before any applied cathodic current pulse, while 2) corresponds to a membrane after a current pulse in a sample containing protamine. An addition of 20 mg L⁻¹ of protamine (final concentration) gives a potentiometric signal change of ca. 16 mV only for 1), suggesting that the current pulse introduces protamine in the membrane, thereby achieving a rapid conditioning of the membrane with protamine.

FIG. 5 shows a) Chronopotentiometric raw data and b) observed potential time-derivates upon successive increases of protamine concentration for a membrane that only contain DNNS (see composition of MC2). As expected with this kind of composition, these membranes were not found to respond to protamine concentration changes (shown in units of mg L⁻¹ final concentration).

FIG. 6 shows a) Chronopotentiometric raw data. Local depletion of protamine is visualized by an inflexion point in the electrochemical readout signal. b) Observed potential time derivates on successively increasing protamine concentration (10-100 mg L⁻¹) for a membrane MC1 (DNNS:TDDA, 2:1 molar ratio). c) Observed linear response of root square transition time as a function of protamine concentration. The protamine diffusion coefficient is obtained from the slope of the calibration curve and the Sand equation. (calibration equation: 0.608+0.0141 C_{protamine(mg/L)}; D=7.01 10⁻⁶ cm²s⁻¹).

FIG. 7 shows reproducibility of the response of three freshly prepared membranes a) under physiological conditions (RSD=3-4%) and b) in undiluted whole blood from a blood bag (RSD=5-6%).

FIG. 8 shows Nyquist plot. Polypropylene membrane doped with NPOE and DNNS-TDDA (in a molar ratio 2:1) gave a bulk resistance of 4 kΩ. This membrane exhibited the typical fingerprint of ion-selective membrane represented by four elements (Rₛ: Solution resistance, Rb: bulk resistance, C: double layer capacitance and W: Warburg diffusion element). The impedance was recorded in potentiostatic mode with a frequency ranging from 1 MHz to 0.1 Hz and 100 mV of amplitude. The spectrum was recorded in solution of physiological conditions (0.1 M NaCl at pH 7.4).

FIG. 9 shows DNNS characterization

FIG. 10 shows a schematic view of an electrochemical cell apparatus including a permselective membrane electrode according to the present invention;

FIG. 11 a) shows the time derivative of the chronopotentiometric responses for a calcium-selective supported membrane containing upon application of a cathodic current. The observed peak maxima signify the localized depletion of calcium at the membrane surface at a transition time that depends directly on the level of calcium in solution (numbers above the peaks are calcium concentrations in units of mM). b) shows the square root of transition time as a function of the applied current amplitude for different calcium concentrations in the sample. For each concentration, a linear dependence is observed, which allows one to tune the experimental conditions to the calcium level. c) The data shown in b) are plotted as square root of transition time multiplied by the applied current, as a function of the calcium concentration. The relationship is linear over all experimental conditions in accordance with the Sand equation.

FIG. 12 demonstrates that the chronopotentiometric protocol with permselective membranes gives information on total concentration. a) shows the time derivatives of the potential transients with increasing concentration of calcium in the sample. b) As a calcium complexing agent nitrilotriacetic acid (NTA) is added to a solution containing 3 mM calcium, only a minor decrease of the transition time is observed, resulting in the apparent calcium concentrations shown in the plot. c) Observed calcium concentration changes (the negative of the logarithmic calcium concentrations, pCa) upon incremental increase of the calcium complexing agent NTA in the sample solution. A classical potentiometric readout with the same type of membranes give information about the uncomplexed (so-called free) calcium ion concentrations in solution, and hence give a sharp decrease in calcium as complexing agent NTA is added. In contrast, the chronopotentiometric protocol give comparably much smaller changes in calcium, which is explained by a change in the diffusion coefficient of the calcium-NTA complex.

FIG. 13 a) time derivative of the response and b) resulting transition times of calcium detection in undiluted whole blood (citrated blood bag) by chronopotentiometry with supported permselective membranes. Standard addition of calcium gives a linear increase of the square root of the transition time and results in a total concentration of calcium that corresponds quantitatively with that obtained by complexometric titration. This method yields total calcium measurement in undiluted and unmodified whole blood.

FIG. 14 shows a schematic of the flow cell currently in use. The protamine selective electrode is on the right (WE), while the blood sample is contacted on the left side with an anion-exchange permselective membrane (FAB). The combination reference/counter electrode is of the type Ag/AgCl and placed in a salt solution on the back side of that FAB membrane. The cell accepts sample volumes on the order of a few tens of microliters.

FIG. 15 (top) shows the time derivatives of this type of flow cell under stopped flow conditions for different concentrations of protamine, each measured three times. The bottom plot shows the corresponding calibration curve of square root of transition time vs. the protamine concentration, indicating linear behavior. Error bars from replicate measurements are also shown.

FIG. 16 shows subtracted coulometric signal (Double pulse technique). The potential was scanned from 0 to 300 mV (steps of 30 mV) for six protamine concentration (inset, concentration of protamine). The outer solution contains: 1 mM NaCl+100 mg L−1 of protamine. Same concentration of NaCl was used as background for samples.

FIG. 17 shows calibration curve in the physiological human range of protamine. (The applied potential was 220 mV respect OCP)

### DETAILED DESCRIPTION OF THE INVENTION

Although methods and materials similar or equivalent to those described herein can be used in the practice or testing of the present invention, suitable methods and materials are described below. All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting.

In the case of conflict, the present specification, including definitions, will control. Unless defined otherwise, all technical and scientific terms used herein have the same meaning as is commonly understood by one of skill in art to which the subject matter herein belongs. As used herein, the following definitions are supplied in order to facilitate the understanding of the present invention.

As herein used, “a” or “an” means “at least one” or “one or more.”

The term “comprise” is generally used in the sense of include, that is to say permitting the presence of one or more features or components.

The term “permselective” membrane as used herein relates to an ion-exchange material that allows ions of one electrical sign to enter and pass through the membrane.

Applicants developed an attractive methodology to quantitatively sense protamine under physiological conditions. This sets the stage for a continuous and convenient monitoring of heparin by protamine titration in blood samples desired in many types of surgeries and kidney dialysis. Protamine is a polycation (˜20 charges per molecule) that plays an important role in the blood coagulation process. It is postsurgically injected to neutralize heparin concentration (a polyanion with a charge of ca. −70) administrated during the procedure to control the blood clotting time. This neutralization is quantitative and rapid, allowing one to detect heparin levels by measuring excess protamine if an adequate electrochemical measurement principle becomes available.

Applicants found out that it is better not to block the spontaneous extraction of protamine into the membrane in order to design a chronopotentiometric sensor. Indeed, a cation permselective membrane (containing excess dinonylnaphthalene sulfonate (DNNS)) can be made thinner and formulated to exhibit higher membrane mobilities. Indeed, since permselective membranes are used in the context of the present invention, it is possible to formulate them to be thinner than the ones proposed in the prior art (such as WO 2005/008232 A1, Auburn University). The prior art suggests the use of membranes without ion-exchanger properties, and extraction of cations on one side had to be accompanied by the extraction of anions at the other membrane side. The electrohcemical properties of the membrane will change if the two ions are allowed to meet in the membrane, posing a geometrical limit on these membranes. In contrast, the minimum thickness in the context of the present invention is dictated by the stability of the membrane. In principle, sub-micrometer membrane thickness is conceivable, although about 25 μm thick membranes are preferably used in the context of the present invention.

Moreover, a substantial initial concentration of analyte ion (ion to be detected and/or concentration thereof to be measured) in the membrane avoids limitations of ion depletion due to membrane polarization and shortens membrane regeneration times after each measurement. Lastly, a defined ratio of free and bound lipophilic reagent selective for analyte ion might allow one to achieve improved ion selectivity in analogy to other charged carrier based membrane systems.

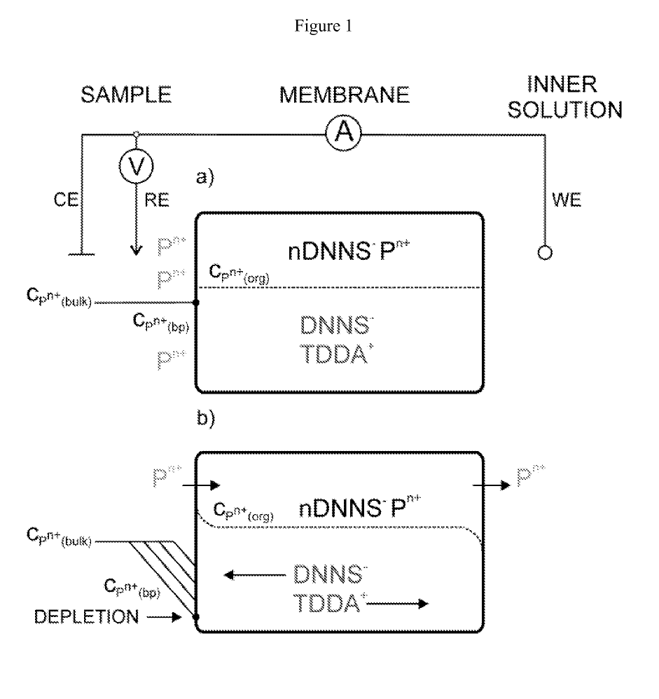

An embodiment of the present invention is exemplified in FIG. 1. According to this particular embodiment, the permselective membrane contains an excess of DNNS over tetradodecylammonium ion (TDDA) that are both dissolved as their respective acid and chloride salt forms in a suitable solvent, which is used to impregnate the pores of the permselective porous membrane. Preferably the suitable solvent is an organic solvent, such as solvent o-NPOE.

Thus the present invention provides a permselective membrane for reversible detection of an analyte ion in a sample, said membrane comprising
a lipophilic reagent for the detection of said analyte ion by dynamic electrochemistry, wherein said lipophilic reagent is either an electrically neutral ionophore or an ion-exchanger, and
a lipophilic ion, wherein said lipophilic ion is either of the opposite electric charge sign as said analyte ion in case an electrically neutral ionophore is present in the permselective membrane or of the same electric charge sign as said analyte ion in case an ion-exchanger is present in the permselective membrane,
wherein said lipophilic reagent is in excess of said lipophilic ion and wherein said lipophilic reagent is selective for said analyte ion.

In a preferred embodiment of the present invention, said dynamic electrochemistry is chronopotentiometry, amperometry, coulometry and similar methods.

The excess of the lipophilic reagent over the lipophilic ion allows at contact of the permselective membrane of the present invention with the sample the spontaneous extraction of ion analyte from said sample into the permselective membrane.

Preferably said lipophilic reagent is substantially in excess of said lipophilic ion. More preferably said lipophilic reagent is in 5% to 200% molar excess of said lipophilic ion; 20% to 160% molar excess; 60% to 140% molar excess.

In another preferred embodiment of the present invention, the excess of said lipophilic reagent over lipophilic ion is 5% molar excess, 10% molar excess, 20% molar excess, 40% molar excess, 50% molar excess, 60% molar excess, 80% molar excess, 100% molar excess, 120% molar excess, 140% molar excess, 160% molar excess or 200% molar excess. More preferably said lipophilic reagent is in a 100% molar excess over said lipophilic ion.

The electrically neutral ionophore may be any lipophilic ion carrier/receptor ordinarily used in ion-selective electrodes, most of which available on the market place from companies such as Fluka or Dojindo. Preferably said electrically neutral ionophore is (−)-(R,R)—N,N′-Bis-[11-(ethoxycarbonyl)undecyl]-N,N′,4,5-tetramethyl-3,6-dioxaoctane-diamide, Diethyl N,N′-[(4R,5R)-4,5-dimethyl-1,8-dioxo-3,6-dioxaoctamethylene]bis(12-methylaminododecanoate) (ETH 1001), N,N,N′,N′-Tetra[cyclohexyl]diglycolic acid diamide, N,N,N′,N′-Tetracyclohexyl-3-oxapentanediamide (ETH 129), N,N-Dicyclohexyl-N′,N′-dioctadecyl-3-oxapentanediamide, N,N-Dicyclohexyl-N′,N′-dioctadecyl-diglycolic diamide (ETH 5234), 10,19-Bis[(octadecylcarbamoyl)methoxyacetyl]-1,4,7,13,16-pentaoxa-10,19-diazacycloheneicosane (K23E1), or N,N-Dicyclohexyl-N′-phenyl-N′-3-(2-propenoyl)-oxyphenyl-3-oxapentanediamide (AU-1).

Preferably said ion-exchanger is selected from the group comprising dinonylnaphthalene sulfonate, tetraphenylborate derivatives, and other selective compounds for analyte ion. More preferably said ion-exchanger is selected from the group comprising dinonylnaphthalene sulfonate and tetraphenylborate derivatives.

Preferably said lipophilic ion is selected from the group comprising anion salts of tetradodecylammonium, dimethyldioctadecylammonium, tetraphenylphosphonium, tetraheptylammonium, tridodecylmethylammonium, and other salts of analogous function.

In a preferred embodiment of the present invention, said analyte ion is a mono-ion (small ion) or polyion. Preferably said mono-ion is a mono-charged ion (K⁺ or Na⁺) or n-charged ion (Ca²⁺). More preferably said mono-ion is calcium, hydrogen ion, hydroxide ion, magnesium, nitrite, fluoride, or phosphate and preferably said polyion is protamine, heparine humic acids, carrageenans, deoxyribonucleic acids, ribonucleic acids and other polyionic macromolecules. The term lipophilic is generally understood to describe a species having an affinity for fat and having high lipid solubility. Lipophilicity is a physicochemical property that describes a partitioning equilibrium of a particular species between water and an immiscible organic.

In the context of the present invention, the lipophilic reagent is selective for analyte ion, which means that said lipophilic reagent facilitates the preferential extraction of one ion over another into the sensing phase.

According a particular embodiment of the present invention, the permselective membrane for reversible detection of protamine in a sample, comprises dinonylnaphthalene sulfonate and tetradodecylammonium, wherein dinonylnaphthalene sulfonate is in excess over tetradodecylammonium and wherein dinonylnaphthalene sulfonate is selective for protamine. Preferably dinonylnaphthalene sulfonate is in a 100% molar excess over tetradodecylammonium.

Dinonylnaphthalene sulfonate (DNNS) is selective for protamine. Protamine selectivity of the lipophilic anion component is dependant upon the functional groups of the anion. Protamine contains basic guanidinium groups (i.e., arginine residues). Therefore, in order to be selective for protamine, the lipophilic anion must include functional groups capable of forming ion pairs with the guanidinium groups of protamine. In a preferred embodiment, lipophilic anions having carboxyhc (COOH), sulfonic (SO₃H), or sulfuric (OSO₃H) groups are used for protamine selectivity. In a particularly preferred embodiment, the lipophilic anion component of the lipophilic electrolyte is DNNS.

In another embodiment according to the present invention, the permselective membrane comprises a lipophilic reagent that is selective for heparin. Heparin selectivity of the lipophilic reagent is dependant upon the functional groups of the compound. Heparin contains sulfonic and carboxyhc groups. Therefore, in order to be selective for heparin, a suitable cation must contain one or more groups that can form ion pairs with the sulfonic and carboxyhc groups of the heparin. Particularly useful in providing heparin selectivity are guanidinium groups. Further, heparin extracted from a sample into an organic sensing phase (such as a membrane according to the present invention) is stabilized by stacking via long aliphatic side chains or aromatic rings of neighboring cations. Therefore, cations with high lipophilicity can be prepared by attaching prepared by attaching one or more guanidinium groups to an aliphatic chain having a chain length of about 4 to about 18 carbon atoms and/or suitable aromatic functionalities. In a preferred embodiment, the lipophilic reagent is dodecylguanidinium or N,N′-1,10-decanediylbis(guanidinium).

The TDDA is a lipophilic cation and can be changed to another lipophilic cation without an expected change in membrane properties. The DNNS can be changed for another protamine selective reagent.

Preferably the permselective porous membrane according to present invention has an average thickness of about 10 μm to about 1000 μm; more preferably of about 20 μm to about 300 μm; the most preferably of about 25 μm.

Preferably the permselective porous membrane according to present invention is a microporous polypropylene or Teflon membrane or a membrane of similar characteristics.

Preferably the permselective membrane according to the present invention is a porous membrane, most preferably a microporous membrane, doped with the lipophilic reagent and the lipophilic ion and solvent/plasticizer. It is also possible to use polymer film forming material without pores, in which case it can be simply a plasticized polymeric membrane.

Preferably said sample is a biological sample. More preferably said sample is a body fluid sample, such as amniotic fluid, blood, breast milk, cerebrospinal fluid, pleural fluid, saliva, mucus fluid or urine. The most preferably said sample is blood sample or urine sample.

In addition to the lipophilic reagent and the lipophilic ion, the membrane according to the present invention can further comprise one or more plasticizers. The plasticizer facilitates mixture homogeneity and also helps control the flux of the ion from the sample solution to the surface of the membrane and into the bulk of the membrane. Various plasticizers can be used in the membrane of the present invention including, but not limited to, plasticizers selected from the group consisting of 2-nitrophenyl octyl ether, dioctyl phthalate, dioctyl sebacate, dioctyl adipate, dibutyl sebacate, dibutyl phthalate, 1-decanol, 5-phenyl-1-pentanol, tetraundecyl benzhydrol 3,3′,4,4′-tetracarboxylate, benzyl ether, dioctylphenyl phosphonate, tris(2-ethylhexyl)phosphate, and 2-nitrophenyl octyl ether. In a preferred embodiment according to the present invention, the plasticizer used in the membrane is 2-nitrophenyl octyl ether (NPOE).

It is generally preferred that that membrane of the present invention, in addition to the lipophilic reagent, the lipophilic ion and the plasticizer, further comprises a substrate material to function as the bulk forming material of the membrane. Multiple substrates for use in forming a permeable membrane are known to those skilled in the art, and it is intended that the present invention encompass all such substrates.

In one embodiment, the substrate material is a polymeric film-forming material. The polymeric film-forming material according to this embodiment can be any polymeric material chemically compatible with the lipophilic reagent, the lipophilic ion and the plasticizer. Further, the polymeric material should be capable of being formed into a film, such as through solvent casting. Polymeric materials useful according to the present invention include, as non-limiting examples, polyvinyl chloride, polyurethane, cellulose triacetate, polyvinyl alcohol, silicone rubber, and copolymers thereof. In one preferred embodiment, the polymeric film-forming material is polyvinyl chloride.

In one embodiment of the invention, the permselective membrane comprises the lipophilic reagent and the lipophilic ion in an amount of about 1 to about 15 weight percent. The membrane according to this embodiment further comprises about 28 to about 49.5 weight percent of a polymeric film-forming material and about 42.5 to about 66 weight percent of a plasticizer (all weights being based upon the total weight of the membrane). Preferentially, the polymeric film-forming material and the plasticizer are present in a ratio of about 1:1 to about 1:2 by weight.

The permselective membrane according to one of the above embodiments can be prepared by solvent casting with an organic solvent, such as tetrahydrofuran (THF), suitable for casting into a thin film. Preferentially, the polymeric film-forming material, the plasticizer, the lipophilic reagent and the lipophilic ion are prepared as a homogeneous solution in the solvent. The solution can then be cast into a thin film. Once prepared as a thin film, the membrane can be cut to any specified size for later use in a ion sensor. Rather than being formed into a thin film, the the membrane solution can be applied to a substrate, such as an electrode, and allowed to dry on the electrode, thereby forming a film directly on the electrode.

According to one embodiment of the present invention, at least one of the lipophilic reagent and the lipophilic ion can be covalently attached to the backbone structure of the polymeric film-forming material. For example, the lipophilic ion can be attached to the polymer chain through copolymerization through vinyl group linkage or some other suitable form of chemical reaction. Further, the lipophilic reagent or lipophilic ion capable of attachment to the polymer structure can be a ion-selective component or a counterion component. The oxidation state of counterion component may be optionally be controllable by electrochemistry so that this component may act as an ion to electron transducer at the back side of the ion-selective membrane. For example, such counterion component may be contain a ferrocene functionality.

In another embodiment, the substrate material is a microporous hydrophobic substrate. According to this embodiment, the plasticizer, the lipophilic reagent and the lipophilic ion are formed into an admixture and then dispersed onto a microporous hydrophobic substrate, wherein the admixture of the plasticizer, the lipophilic reagent and the lipophilic ion are taken up into the pores of the substrate and allowed to cure. The microporous hydrophobic substrate with the plasticizer, the lipophilic reagent and the lipophilic ion dispersed therein can then be processed for use in a ion sensor. The microporous hydrophobic substrate according to one embodiment of the invention, can be selected from the group consisting of polyethylene, polypropylene, nylon, polyvinylidene fluoride, polycarbonate, polytetrafluoroethylene, acrylic copolymer, polyether sulfone, and copolymers and terpolymers thereof. According to one preferred embodiment, the microporous hydrophobic substrate is polyethylene. Particularly preferred as the microporous hydrophobic substrate are Celgard® membranes, available from Celgard, Inc., Charlotte, N.C. Celgard® membranes are polyethylene-based membranes available as flat sheet membranes and hollow fiber membranes.

In one preferred embodiment of the present invention, the permselective membrane comprises a microporous hydrophobic substrate that has been contacted with an admixture comprising about 1 to about 15 weight percent of the lipophilic reagent and the lipophilic ion and about 85 to about 99 weight percent of a plasticizer, based on the total weight of the mixture.

The amount the lipophilic reagent and the lipophilic ion present in the membrane according to the present invention can vary depending upon the physical properties of the membrane, which can limit the solubility of a salt in the membrane. Preferably, the lipophilic reagent and the lipophilic ion are present at about 1 to about 15 weight percent based upon the total weight of the membrane. More preferably, the lipophilic reagent and the lipophilic ion are present at about 5 to about 12 weight percent based upon the total weight of the membrane. In one preferred embodiment, the lipophilic reagent and the lipophilic ion are present at about 10 weight percent based upon the total weight of the membrane.

The membrane is mounted into a commercial electrode body (see Examples). Such supported membranes were chosen here because they allow for an efficient equilibration with the sample solution in a matter of minutes and exhibit attractive ion mobilities. Indeed, upon first exposure to a protamine containing solution, the hydrogen ion counter ion of DNNS may quantitatively exchange with protamine, resulting in a permselective membrane, while excess HCl from the DNNS-TDDA electrolyte are similarly expelled.

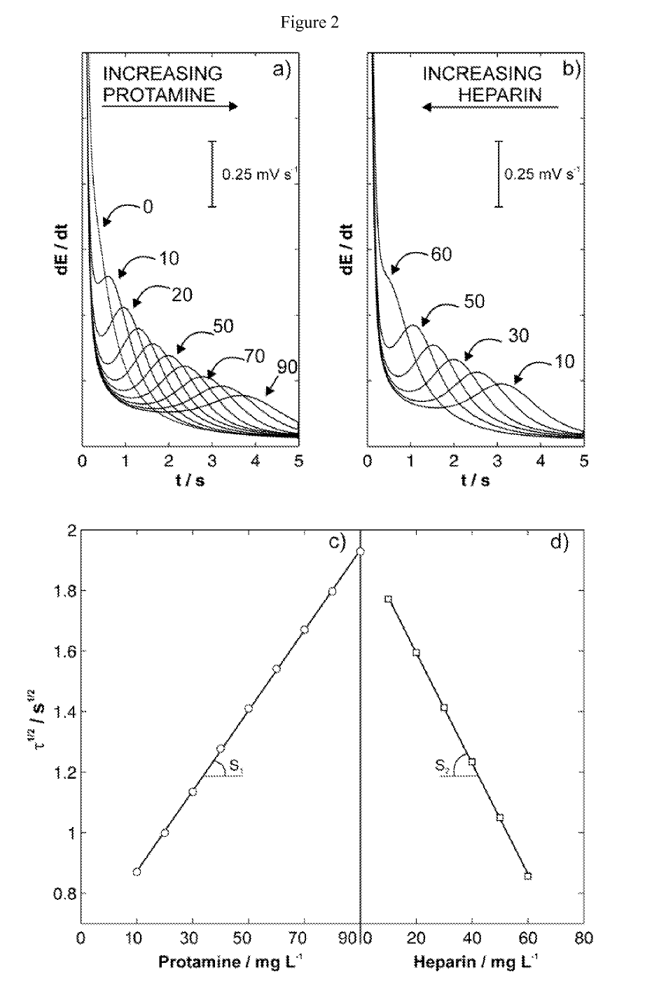

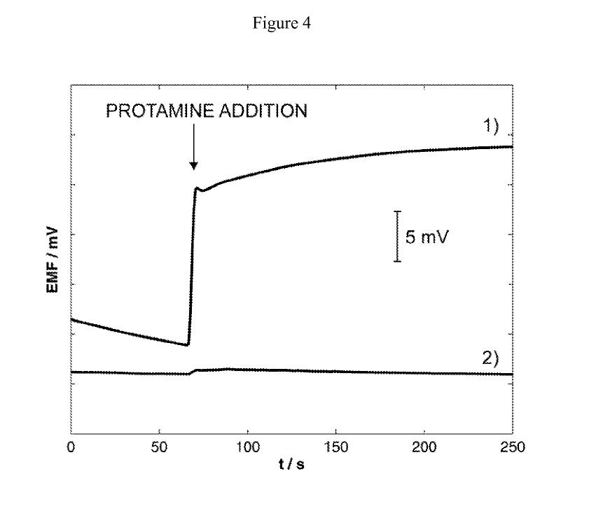

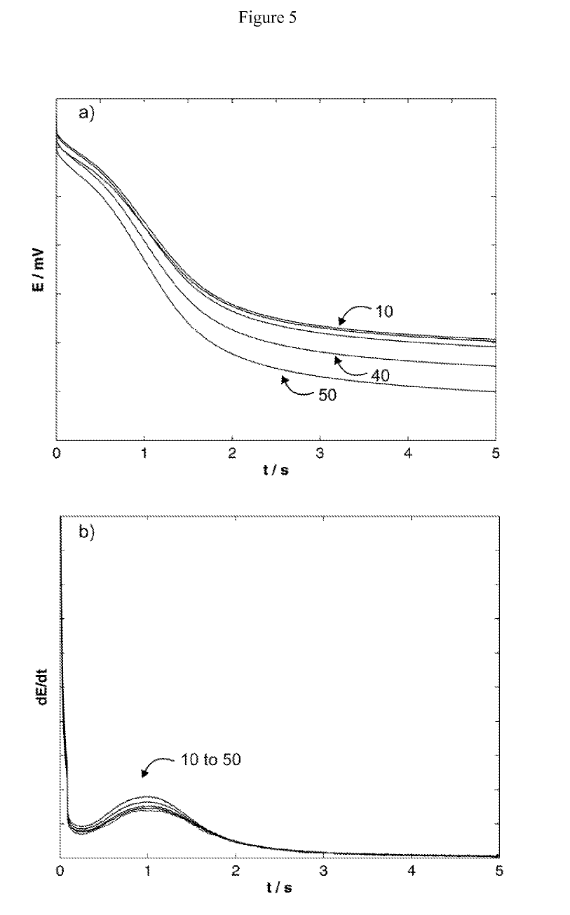

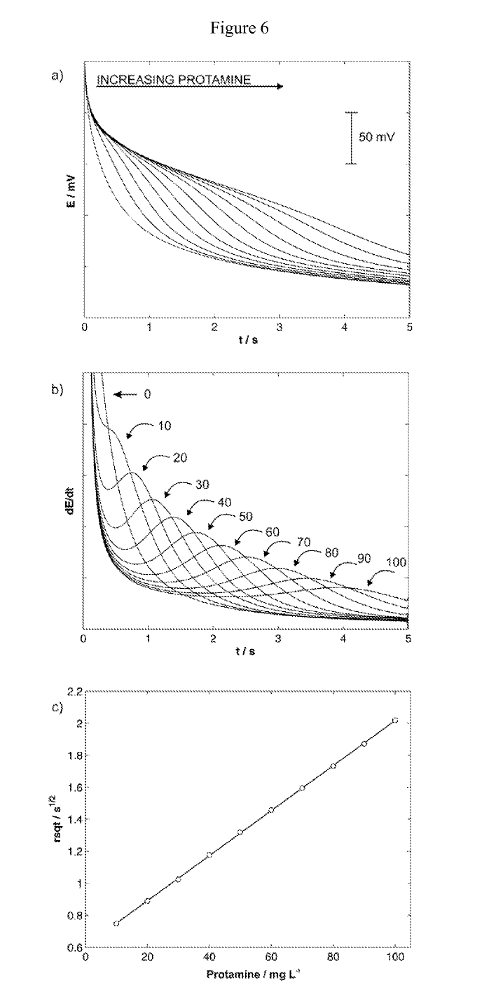

An applied constant current pulse imposes the transport of protamine from the sample across the membrane into the inner solution with a defined flux. This transport results in a required protamine accumulation at the sample side of the membrane, which is facilitated by the presence of the salt DNNS-TDDA in the membrane, as schematically shown in FIG. 1 (see also potentiometric measurement FIG. 4). Indeed, membranes containing only DNNS as active ingredient did not give operational responses with the methodology discussed here (FIG. 5). The transition time (τ) is found as the inflection of the chronopotentiometric response (see FIG. 6) and signals the local depletion of protamine at the membrane surface (FIG. 1b). After this transition time, a background cation such as sodium is co-extracted along with protamine to maintain the imposed ion flux, which results in a decreased membrane potential. The transition is conveniently visualized as the maximum of the time derivative of the potential as shown in FIG. 2a-b for different protamine concentrations. After each chronopotentiometric protamine determination, a potentiostatic pulse is applied for 30 s at the open circuit potential determined before the current pulse. This is to return the membrane concentration gradients to a state close to the unperturbed situation shown in FIG. 1a.

FIG. 2 demonstrates the quantitation of protamine in buffered 0.1 M NaCl samples (Tris pH 7.4) at an applied cathodic current density of 21 μA cm⁻². FIG. 2a shows the concentration dependent potential changes that are used to find the transition time. FIG. 2c plots the square root of the transition time as a function of protamine concentration, demonstrating the linear calibration curve expected from the Sand equation (see equation 1 in Examples). In principle, a change in current density results in a variation of the transition time and hence can be used to fine tune the available measuring range. The slope of the calibration curve shown in FIG. 2c (s₁/[s^{1/2}]=0.741+0.0133 c_{Protamine}/[mg L⁻¹]), along with a charge for protamine of +21 and the known membrane area of 0.237 cm², gives a diffusion coefficient for protamine of 6.20 10⁻⁶ cm² s⁻¹.

FIG. 2b shows the time derivatives of the observed potential upon addition of the indicated final concentrations of heparin to the sample containing 90 mg L⁻¹ protamine, again in 0.1 M NaCl at pH 7.4. The transition times are incrementally reduced with increasing levels of heparin, suggesting a quantitative deactivation of protamine by polyion interactions. This is quantitatively visualized in FIG. 2d as again a linear dosage curve that suggests that 65 mg L⁻¹ heparin is required to fully neutralize the 90 mg L⁻¹ protamine concentration (s₂/[s^{1/2}]=1.958−0.0183 c_{Protamine}/[mg L⁻¹]). This is in agreement with earlier findings where the experimental binding ratio was 1.4 to 1.^{2f,4b} Unlike previous reports to develop protamine responsive sensors, the principle reported here yields linear calibration curves.

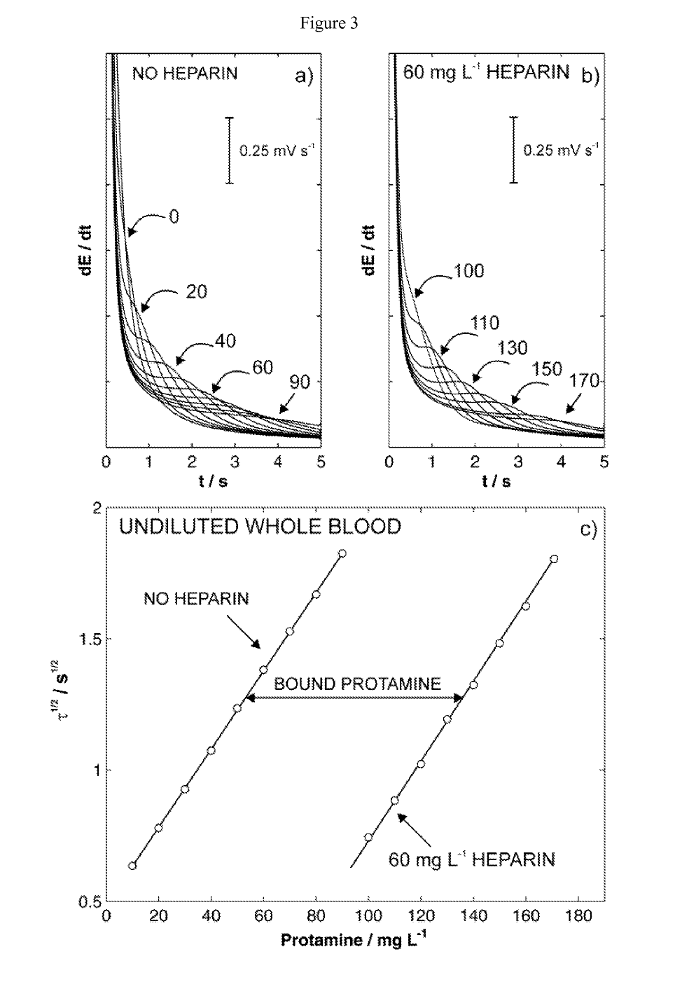

The principle was evaluated in preliminary work in undiluted human whole blood (citrated blood bag, kindly provided by the university hospital of Geneva, HUG). FIGS. 3a and 3b demonstrate that the potential transients yield transition times in complete analogy to that shown in FIG. 2 for electrolyte solutions. The square root vs. concentration plot (FIG. 3c) is linear and is described by 0.0149 c_{Protamine}/[mg L⁻¹]+0.482, giving a diffusion coefficient of protamine of 7.83 10⁻⁶ cm² s⁻¹. In a separate experiment, the blood sample was spiked with 60 mg L⁻¹ (final concentration) of heparin. Protamine additions give visible transition times at above 85-90 mg L⁻¹ added protamine (see FIG. 3c), which is consistent with the results presented above that 60 mg L⁻¹ heparin should bind with approximately 85 mg L⁻¹ protamine.

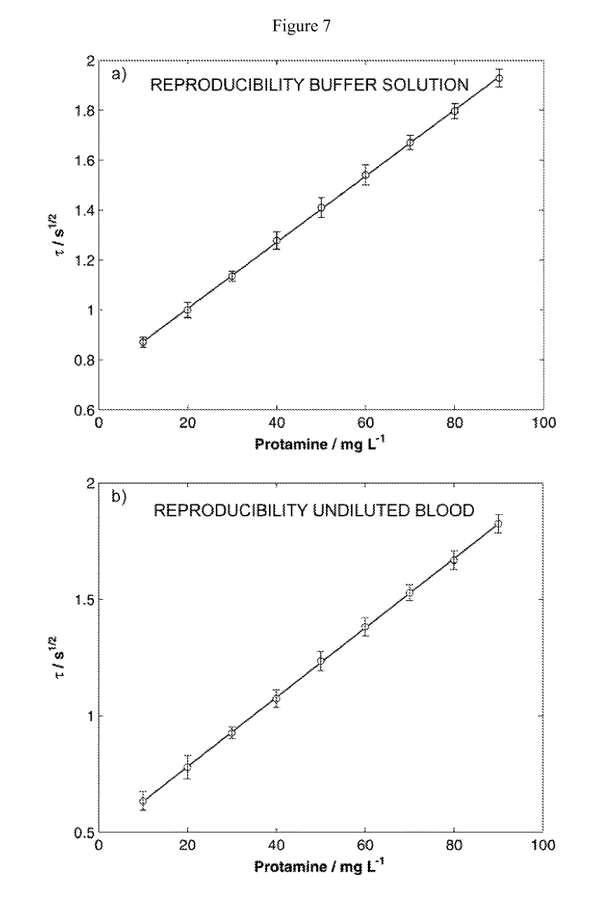

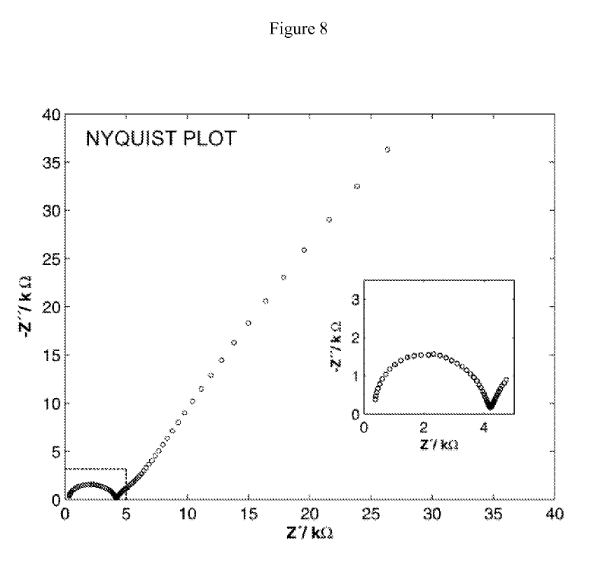

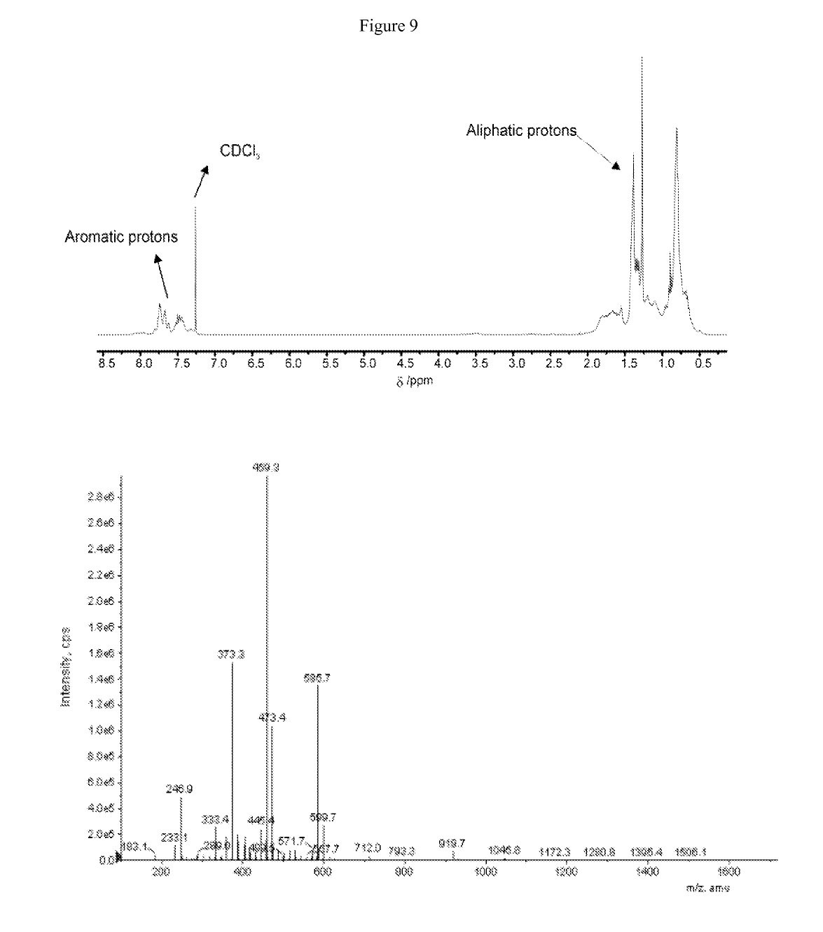

The corresponding dose response shown in FIG. 3c is again linear and described with 0.0153 c_{Protamine}/[mg L⁻¹]−0.806. Most interestingly, the dose response curves exhibit nearly the same slopes but are offset by the amount of protamine bound by the heparin in the sample. The offset offset corresponds to 85 mg L⁻¹, as expected. The reproducibility between three different freshly prepared membranes was found to be acceptable, with an RSD of 3-4% and 5-6% for electrolyte solution and blood experiments, respectively. Depending on the desired precision, a calibration of the sensor will be required for practical use. The reproducibility from data using a single membrane displays a RSD of 1% (FIG. 7).

The chemical approach introduced here uses permselective membrane electrodes that allow one to employ supported liquid membranes that exhibit higher mobilities and rapidly equilibrate with the contacting samples. The square root of chronopotentiometrically observed transition times correlate linearly with protamine concentration in a range that can be tuned by the magnitude of applied current. Experiments in 0.1 M NaCl electrolyte backgrounds and in undiluted whole blood suggest negligible interference by the sample matrix, making it a promising approach for the continuous monitoring of heparin in clinical settings.

The same general embodiment can alternatively be used to deliver protamine from the ion-selective membrane during a short galvanostatic pulse to the stagnant blood sample, where it is allowed to bind to any heparin present. The pulse duration for this protamine delivery step is anywhere between 100 ms and 1 min. Heparin-protamine interaction is by polyelectrolyte binding, and therefore very rapid (diffusion controlled). Immediately after the protamine delivery pulse, a current of opposite direction is applied in order to detect unreacted protamine. The observed transition time will change as a function of heparin concentration in the blood sample and can be used as analytical signal. The advantage of this extended protocol is that the protamine delivery is performed by electrochemical means at the site of detection, rather than by fluidic mixing.

The same general embodiment can alternatively be used in a thin layer coulometric sensing protocol. For this purpose, the sample solution is delivered into a thin layer of 10 to 150 μm thickness that is contacting the protamine selective membrane and a suitable inner reference element. The physical arrangement of the membrane and sample can be of a tubular form, where the sample solution is placed inside the tube and the tubular walls are formed by the protamine selective membrane. A suitable potential applied between an electrode placed in the outer solution and the inner reference element results in the transport of protamine from the sample solution to the outer solution across the membrane. The associated current is integrated over the course of up to 5 min, depending on the dimensions of the thin layer cell, in order to arrive at the charge of protamine transferred. The charge serves as the analytical signal and is proportional to the protamine concentration in the sample. Optionally, protamine can be delivered by galvanostatic control to the unmodified sample across the same protamine selective membrane before coulometric measurement. This strategy is analogous to the approach described directly above, but the thin layer sample allows one to equilibrate the entire sample plug with protamine for better reproducibility. The advantage of a coulometric detection principle is the improved robustness of the technique with regards to temperature fluctuations and membrane adsorption phenomena, but requires a longer measurement time.

The present invention further provides a permselective membrane electrode that is useful in an electrochemical cell. In one embodiment of the invention, the permselective membrane electrode comprises
a housing;
a reference solution contained within said housing;
an electrode operatively positioned within said housing so as to be in contact with said reference solution; and
the permselective membrane according to the present invention disposed at one end of said housing and in contact with said reference solution within said housing, and being operatively positioned for contacting a sample solution external to said housing.

Any standard electrode could be used according to this embodiment of the invention, so long as the electrode is capable of incorporating a permselective membrane of the present invention. The particularly preferred embodiment of the present invention, the membrane electrode comprises a permselective membrane incorporated into a standard electrode, such as a Philips electrode body (IS-561, Glasblaserei Mδller, Zurich, Switzerland).

Preferably the reference solution used in the electrode housing can be any electrolyte solution generally known to one skilled in the art as being useful. In one preferred embodiment, the electrolyte solution is a sodium chloride solution, in particular, a 1 M NaCl solution. Further, the electrode itself can be any type of electrode capable of use in electrochemical cells of potential and current values as described below.

Preferably said electrode is a Ag/AgCl electrode.

When used with a membrane electrode, it is preferable that the permselective membrane have a surface area of about 10 mm² to about 100 mm². More preferable is a surface area of about 20 mm² to about 50 mm². To achieve such surface areas, a thin film can be prepared, as described above, and the thin-film cut to the desired size, such as with a cork borer, for association with the electrode.

In another embodiment, the present invention provides a method of measuring the concentration of an analyte ion in a sample solution, comprising:
providing a sample solution comprising said analyte ion and a background electrolyte;
contacting said sample solution with the permselective membrane electrode according to the present invention for a sufficient period of time in order to allow spontaneous extraction of said analyte ion from the sample solution into the membrane;
contacting the sample with a reference electrode, wherein the permselective membrane electrode and the reference electrode are electrically connected;
applying an external current pulse of fixed duration to a circuit comprising the membrane electrode and the sample solution, thereby driving transport of analyte ion from the sample solution into the membrane;
measuring a potential response during the current pulse between the membrane electrode and the reference electrode; and
calculating the concentration of analyte ion as a function of the chronopotentiometric response.

According to an embodiment of the present invention, the method of measuring the concentration of an analyte ion in a sample solution is in-vitro method.

The sufficient period of time to allow spontaneous extraction of analyte ion from the sample solution into the membrane depends on the mobility of the sensing phase. For example using a doped polypropylene membrane, it is quite rapid, on the order of one minute. Preferably fast diffusing membranes are used in the context of the present invention.

Preferably the potentiometric response is measured over a period of time that is less than the total fixed duration of the external current pulse. Preferably the fixed duration of the external current pulse is about 0.1 to about 2 seconds. Preferably the potentiometric response is measured during the last about 100 milliseconds of the fixed duration of the external current pulse.

While the circuit to which the external current is applied generally comprises the permselective membrane electrode and the sample solution, the circuit will also comprise one or more further components of the electrochemical cell. For example, in one embodiment according to the invention, the circuit further comprises a counter electrode. Preferably the counter electrode is comprised of a platinum wire. This embodiment would encompass electrochemical systems conventionally referred to as “three-electrode” electrochemical cells. Additionally, in another embodiment, the circuit further comprises a reference electrode. Preferably the reference electrode comprises a double junction electrode. This embodiment encompasses electrochemical systems conventionally referred to as “two-electrode” electrochemical cells. Three-electrode systems are typically preferred to avoid degradation of the reference electrode that can occur when an external current is applied to such electrodes.

The value of the potential measured in the above method depends upon the type of ion present in the sample. For example, if a cation, such as protamine, is present, a cathodic current (negative) is applied to the cell. When the current is applied, the measured potential becomes more negative. When an anion, such as heparin, is present, an anodic current (positive) is applied to the cell. When the current is applied, the measured potential becomes more positive.

The absolute value of the potential measured in the above method will generally be expected to decrease with time due to the steadily increasing diffusion layer thickness in the membrane. As described above, when testing for the presence of a poly-cation, such as protamine, a cathodic current is applied and a negative potential is observed. When protamine (or another poly-cation) is present in the sample, the potential measured is significantly more positive than if the poly-cation is not present. Conversely, when testing for the presence of a poly-anion, an anodic current is applied and the observed potential is positive. If heparin (or another poly-anion) is present in the sample, the measured potential would be expected to be significantly more negative than if the poly-anion is not present, in both cases, the move toward a more positive or more negative charge is indicative of polyion extraction from the sample solution into the membrane. After sufficient time, the measurement would begin to fail due to the accumulation of the polyion in the membrane.

In another embodiment of the present invention, the method further comprises applying an external electrode potential to the permselective membrane electrode and the reference electrode, thereby driving transport of the analyte ion from the membrane. In this embodiment, the method allows for a reversible sensor, wherein the analyte ion is back-extracted, and the permselective membrane thus being reconditioned for further use. The sensor is operationally reversible for several days. Reversibility is achieved electrochemically, so the sensor does not have to be removed from the sample solution for this purpose. It does not have to be chemically regenerated as in the prior art.

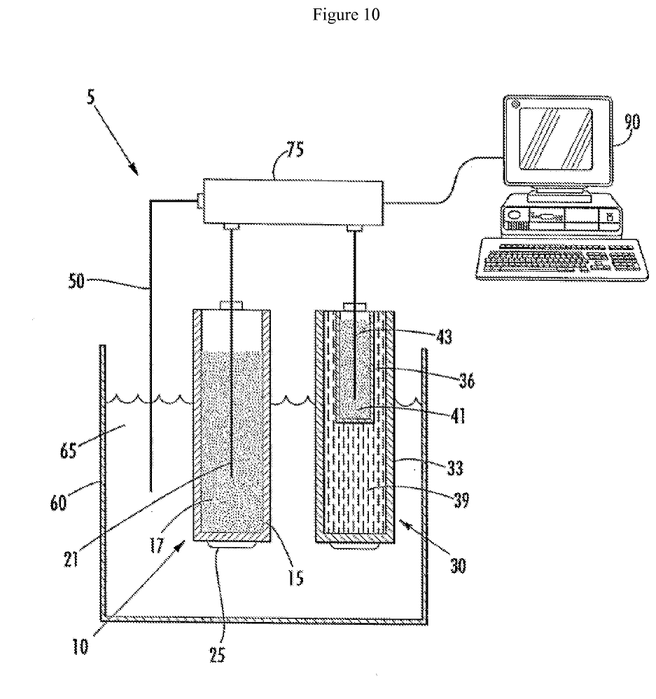

Continuous, reversible detection of an analyte ion becomes possible by repeatedly applying the external current pulse, measuring the potentiometric response, calculating the concentration of analyte ion, and applying the external potential pulse. Preferably the external electrode potential is a baseline potential. The value of the baseline potential can vary depending upon the symmetry of the electrochemical cell. For example, in one embodiment, the membrane electrode and the reference electrode use identical electrodes and have inner reference solutions that are similar in composition to the sample solution. Most preferably the baseline potential is 0 V. Additional embodiments are also envisioned, wherein the electrodes exhibit less symmetry in varying degrees. In these additional embodiments, the baseline potential would be expected to vary from 0 V. The optimal baseline potential may be determined by disconnecting the electrochemical instrument (see FIG. 10), and replacing it with a high impedance voltmeter to measure the zero current potential between the membrane electrode and the reference electrode.

Preferably the external electrode potential is applied for a duration of time that is about 10 to about 20 times longer than the fixed duration of the external current pulse in order to effectively strip the ion analyte from the membrane.

In a further embodiment of the present invention, the method can be used in continuous manner, such as automatic real-time analyte ion monitoring during surgery, without need to take blood samples. For example an aliquot of whole blood is mixed with a solution containing a precisely known quantity of protamine. This can be conveniently done by flow injection followed addition of the protamine reagent stream that mixes online in a mixing tube. The mixed solution is guided to a measurement cell where it makes contact with the selective electrode and, through a liquid junction, the reference electrode. The counter electrode can either be a metal based counter electrode in direct contact with the sample (in a three electrode configuration) or be identical to the reference electrode (in a two electrode configuration). The inner solution of the membrane contains the working electrode. This cell arrangement measures excess, unreacted protamine, and this value is used to calculate the concentration of heparin in the sample.

The combination of permselective membranes and chronopotentiometric readout can find uses outside of specific ions detection and/or measuring concentration of specific ions, such as protamine or heparin. A calcium-detection and measuring system has been also developed by the Applicants in the very same manner, which allows detecting total calcium (as opposed to unbound, or free calcium) in undiluted blood samples. In addition, other polyions can also be detected, as well, transition metals and many anions.

The present invention is further directed to an electrochemical cell apparatus. Thus according to an embodiment of the present invention, the electrochemical cell apparatus comprises

i) a permselective membrane electrode according to the present invention;

ii) a reference electrode electrically connected to said membrane electrode; and

iii) an electrochemical instrument operatively connected to said membrane electrode and said reference electrode.

Preferably the electrochemical cell apparatus according to the present invention further comprising a counter electrode electrically connected to said permselective membrane electrode. Most preferably said counter electrode comprises a platinum wire.

Preferably the electrochemical cell apparatus according to the present invention further comprising a controller device in communication with said electrochemical instrument. Most preferably said controller device comprises a computer. Preferably said electrochemical instrument is a galvanostat-potentiostat or a bipotentiostat.

One embodiment of an electrochemical cell apparatus according to the present invention is provided in FIG. 10, which shows an electrochemical cell apparatus 5 useful for measurement of an ion analyte in a sample. FIG. 10 shows a permselective membrane electrode 10, a reference electrode 30, and a counter electrode 50 operatively positioned in a testing sample container 60 having disposed therein a sample solution 65. The membrane electrode 10 comprises an electrode housing 15, a reference solution 17, and a reference electrode wire 21. Disposed at one end of the electrode housing 15 is a permselective membrane 25 according to the present invention. The reference electrode 30, as shown in FIG. 10, is a double-junction electrode, although other types of reference electrodes could be used without departing from the invention. The reference electrode 30 includes an outer housing 33, an inner housing, 36, an outer housing reference solution 39, an inner housing reference solution 41, and a reference electrode wire 43. As seen in FIG. 10, the permselective membrane electrode 10, the reference electrode 30, and the counter electrode 50 are each operatively connected to an electrochemical instrument 75, which is further in communication with a controller device 90. The electrochemical instrument 75 is preferably a galvanostat-potentiostat. Accordingly, the electrochemical instrument is capable of controlling the current through the electrochemical cell at a preset value and is also capable of controlling the electrical potential between the working electrode (e.g. the permselective membrane electrode 10) and the reference electrode 30 at a preset value. In performing the latter function, the electrochemical instrument 75 is capable of forcing whatever current is necessary between the working electrode (e.g. the permselective membrane electrode 10) and the counter electrode 50 to keep the desired potential. In one particularly preferred embodiment, the electrochemical instrument 75 is a bipotentiostat, such as an AFCBP1 Bipotentiostat available from Pine Instruments (Grove City, Pa.).

The controller device 90, as shown in FIG. 10, is preferably a computer capable of carrying out an algorithm designed to automatically regulate the function of the electrochemical instrument 75 in controlling current, potential, or electrochemical activity desirable. The controller device 90 is also preferably capable of collecting data from the electrochemical instrument 75 and displaying the data visually to the user and/or storing the data. Of course, it is understood that both the electrochemical instrument 75 and the controller device 90 in FIG. 10 would be connected to a power supply (not shown).

Those skilled in the art will appreciate that the invention described herein is susceptible to variations and modifications other than those specifically described. It is to be understood that the invention includes all such variations and modifications without departing from the spirit or essential characteristics thereof. The invention also includes all of the steps, features, compositions and compounds referred to or indicated in this specification, individually or collectively, and any and all combinations or any two or more of said steps or features. The present disclosure is therefore to be considered as in all aspects illustrated and not restrictive, the scope of the invention being indicated by the appended Claims, and all changes which come within the meaning and range of equivalency are intended to be embraced therein.

The foregoing description will be more fully understood with reference to the following Examples. Such Examples are, however, exemplary of methods of practising the present invention and are not intended to limit the scope of the invention.

### EXAMPLES

### Protamine Detection/Measurement System

### Reagents and Solutions

Tetradodecylammonium chloride (TDDA), 2-nitrophenyl octyl ether (o-NPOE), Heparin sodium salt from porcine intestinal mucosa (H4784), Protamine sulfate salt from herring (P4505), Trizma hydrochloride (Tris.HCl), sodium chloride, sodium hydroxide (1M) and tetrahydrofuran THF were purchased from Sigma-Aldrich. Dinonylnaphthalene sulfonate (DNNS acid form in 50% heptane) was a gift from King Industry. Heparin and protamine stocks solution (10 g L⁻¹) were freshly prepared before starting the experiments in Tris buffer (10 mM buffer at pH 7.4+100 mM NaCl).

### Electrochemical Equipment

A double-junction Ag/AgCl/3M KCl/1 M LiOAc reference electrode was used in the potentiometric and chronopotentiometric measurements (Mettler-Toledo AG, Schwerzenbach, Switzerland). Electrode bodies (Oesch Sensor Technology) were used to mount the polymeric membranes. A platinum working rod (3.2 cm² of surface area) was used as a counter electrode. Potentiometric calibration was performed using a 16-channel EMF monitor (Lawson Laboratories, Inc., Malvern, Pa.) connected to a personal computer. Chronopotentiometric and electrochemical impedance spectroscopy measurements were performed with an Autolab PGSTAT302N (MULTI 16, module, Metrohm Autolab, Utrecht, The Netherlands) that allows one read up to 16 working electrodes placed in the same electrochemical cell. A faraday cage was used to protect the system from undesired noise.

### Membrane Preparation

DNNS stock solution was prepared in THF (112 mg of dry DNNS in 1 mL of THF) and used to prepare the membrane cocktail labeled as MC1 composed by 11.8 mg of DNNS, 8.82 mg of TDDA (2:1 molar ratio respectively), 180 mg of o-NPOE and 1 mL of THF. The solvent was allowed to evaporate overnight from the cocktail. MC2 that only contained the same quantity of DNNS and no additional TDDA was also prepared.

Porous polypropylene membranes (Celgard brand, 0.237 cm² of surface area) were used as supporting material. The membranes were washed with THF for 10 min to remove any possible contaminants. When the membrane was found to be completely dry, 3 μL of the cocktail solution (see above) was deposited on it. The impregnation of the cocktail was found to be instantaneous; however, the membrane was let in the Petri Dish for ca. 10 min to ensure a homogenous and reproducible impregnation of the pores. Afterwards, the membrane was conditioned in the buffer solution for 20 min. Finally, the membrane was mounted in the electrode body. Both inner and outer compartments were composed of the same background solution and concentration before starting the experiment. Protamine or heparin stock solutions were always successively added to the outer compartment.

### Chronopotentiometry

The method consists of three steps: i) Open circuit potential determination for 5 s (no current flow through the electrochemical cell), ii) Cathodic constant current pulse for 5 s (perturbation and sensing step), iii) Constant potential pulse for 30 s (same potential as recorded in i), regeneration membrane step).

### DNNS Characterization

DNNS solution (50% in heptane) was evaporated in a rotating evaporator for 1 h (50° C. at 100 mbar). The brown oil remaining in the flask was analyzed by NMR and mass spectroscopy. Both complementary data confirmed the presence of pure DNNS. NMR (Bruker 400 Mhz NMR spectrometer) spectrum (on the top) clearly shows two different regions: the aromatic region (δ=7.45 and δ=7.55 corresponding to 5H); and the aliphatic region (from δ=0.6 to δ=1.9 corresponding to X H). The mass spectrum was obtained in negative electrospray conditions (on the bottom). The peak at 459.3 amu corresponds to the calculated mass of DNNS.

$$\sqrt{D} = \frac{i \sqrt{π τ}}{2 nFAc} \qquad Equation 1 \text{-} Sand Equation$$

D corresponds to diffusion coefficient (i.e, protamine), i is the applied current (5·10⁻⁶ A), τ is the transition time, n corresponds to the total ion charge (i.e, 21 charges for protamine), F is the Faraday physical constant (96485 C mol⁻¹), A is the area of the membrane (0.237 cm²) and c is the concentration of protamine (mol L⁻¹ using as Mw 51 kD). The obtained slopes shown in the manuscript corresponds to τ^{1/2}c⁻¹.

### Calcium Detection/Measurement System

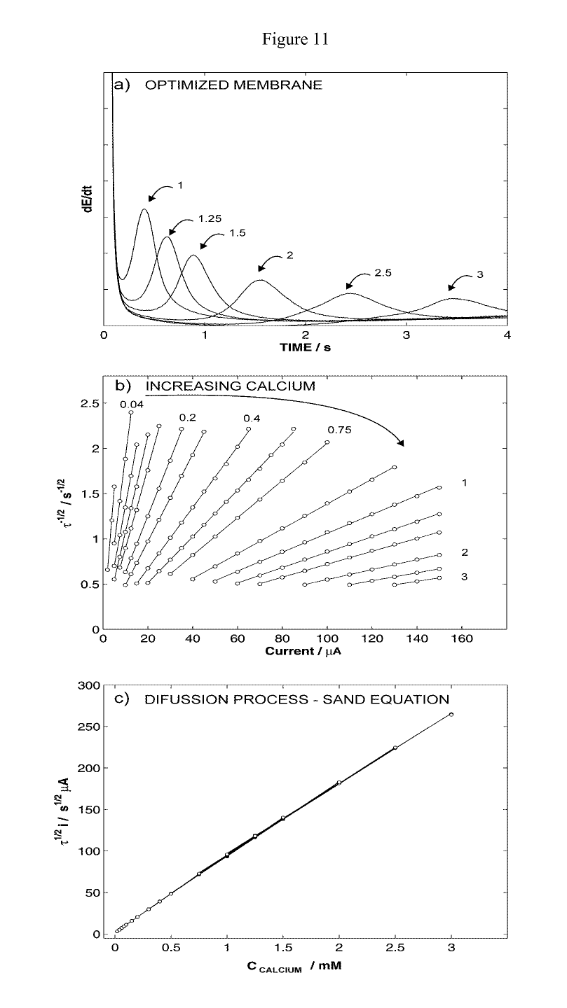

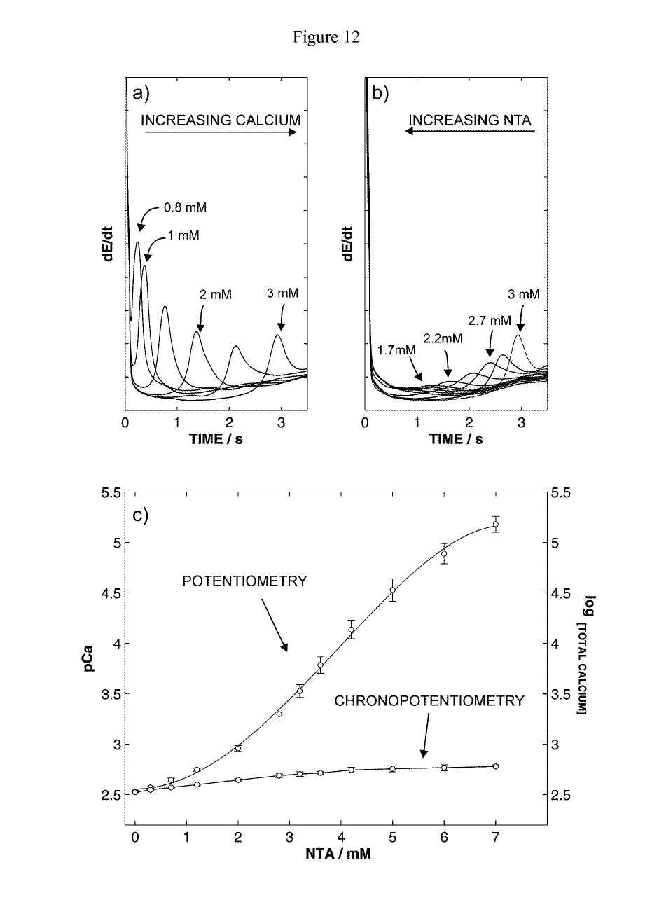

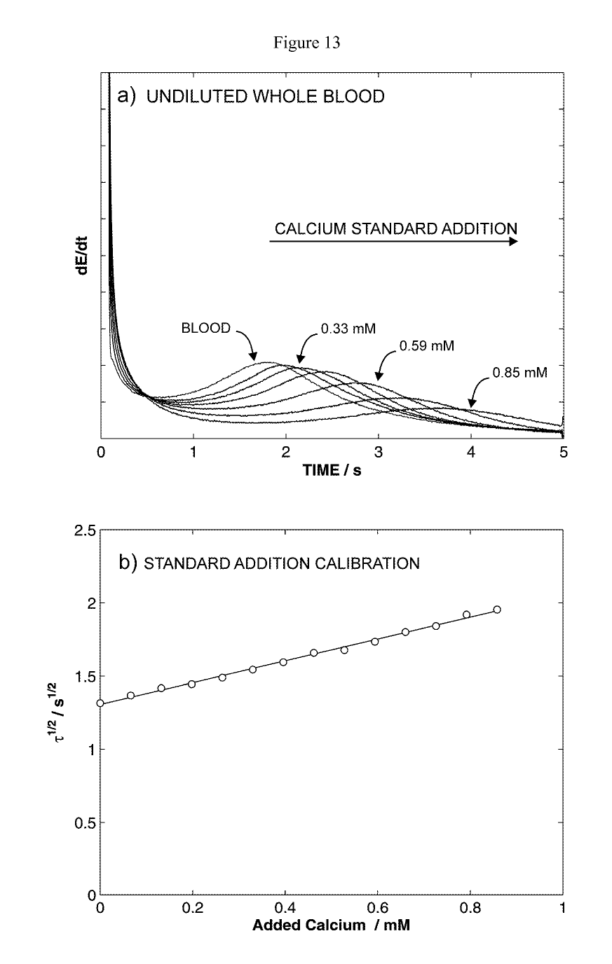

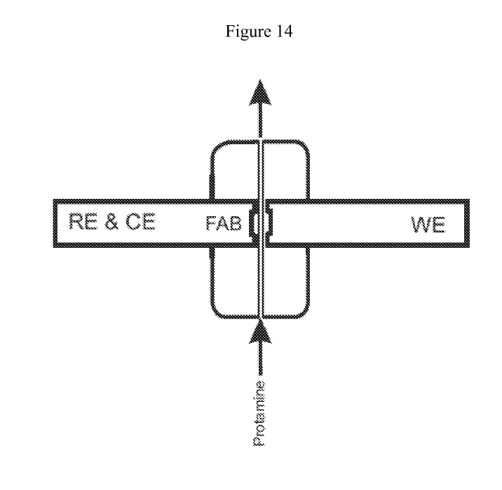

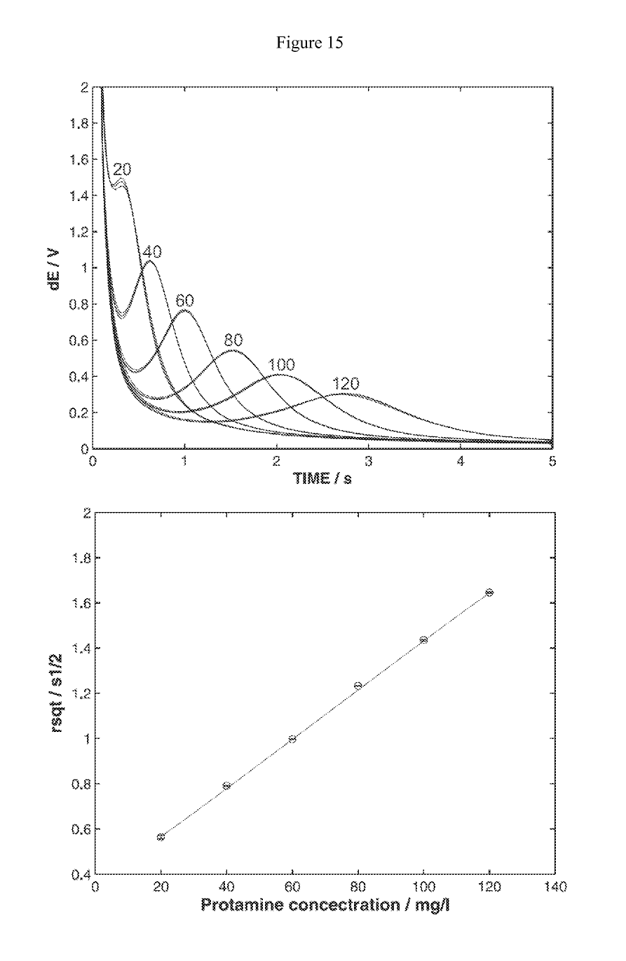

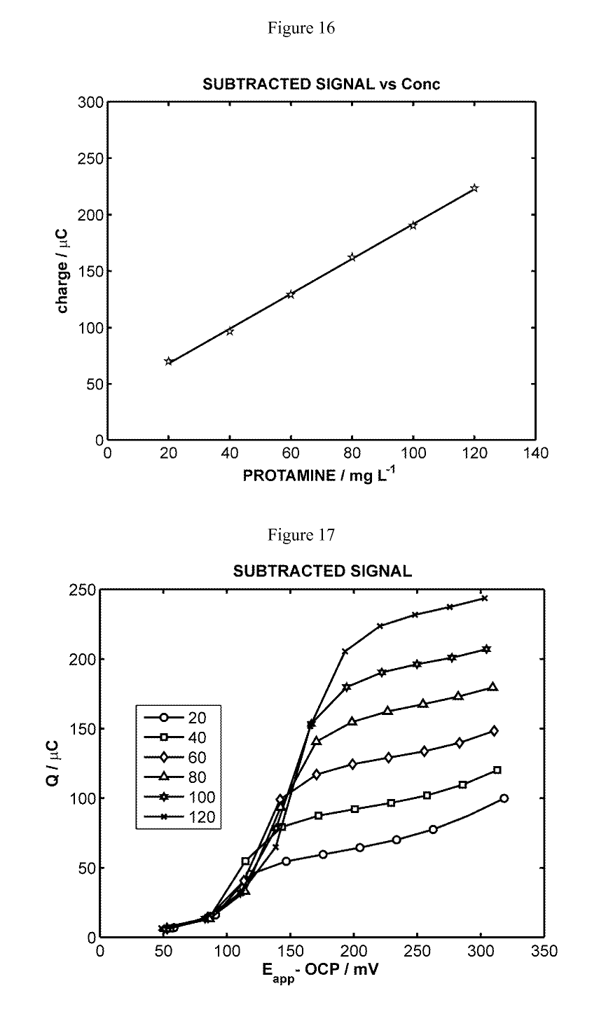

A calcium-detection system was developed in the very same manner. It allows one to detect total calcium (as opposed to unbound, or free calcium) in undiluted blood samples (see FIGS. 11, 12 and 13).

### Reagents and Solutions

Potassium tetrakis[3,5-bis(trifluoromethyl)phenyl]-borate (KTFPB), Sodium tetrakis[3,5-bis(trifluoromethyl)phenyl]-borate (NaTFPB), Tetrakis(4-chlorophenyl)borate tetradodecyl-ammonium salt (ETH500), potassium ionophore I, N,N-Dicyclohexyl-N′,N′-dioctadecyl-3-oxapentanediamide, N,N-Dicyclohexyl-N′,N′-dioctadecyl-diglycolic diamide (ETH 5234, also known as calcium ionophore IV), 2-nitrophenyl octyl ether (o-NPOE), dioctylsebacate (DOS), high molecular weight poly(vinyl chloride) (PVC), Trizma hydrochloride (Tris.HCl), Nitrilotriacetic acid (NTA) sodium chloride, sodium hydroxide (1M) and tetrahydrofuran (THF) were purchased from Sigma-Aldrich (analytical grade). All the experiments were performed in Tris buffer (10 mM buffer at pH 7.4+100 mM NaCl).

### Electrochemical Equipment

A double-junction Ag/AgCl/3M KCl/1 M LiOAc reference electrode was used in the potentiometric and chronopotentiometric measurements (Mettler-Toledo AG, Schwerzenbach, Switzerland). Electrode bodies (Oesch Sensor Technology) were used to mount the polymeric membranes. A platinum working rod (3.2 cm² of surface area) was used as a counter electrode. Selectivity coefficient were determined by potentiometric employing a high impedance input 16-channel EMF monitor (Lawson Laboratories, Inc., Malvern, Pa.). Potentiometric, chronopotentiometric and electrochemical impedance spectroscopy measurements were performed with an Autolab PGSTAT302N (MULTI 16, module, Metrohm Autolab, Utrecht, The Netherlands) that allows one read up to 16 working electrodes placed in the same electrochemical cell. A faraday cage was used to protect the system from undesired noise.

### Membranes Preparation

Potassium PVC membrane were prepared in the classical manner using the regular ratio between ionophore-cation exchanger and PVC-plasticizer (1:2). 15 mmol kg⁻¹ of Ionophore I, 5 mmol kg⁻¹ of NaTFPB, 20 mmol kg⁻¹ of ETH500, 63 mg of PVC, 127 mg of DOS were properly dissolve in THF. The cocktail was poured into a glass ring (10 mm ID) affixed onto a glass sheet. The solution was allowed to evaporate overnight. The thicknesses of the resulting membranes were ca. 0.2 mm. This mother membrane was cut with a hole puncher into small disks (5.7±0.2 mm diameter) and mounted into the electrode body. After that, the membranes were conditioned either in 1 mM of NaCl or 1 mM of KCl.

Porous polypropylene (PP) membranes (Celgard brand, 0.237 cm² of surface area, 25 μm thickness) were used as supporting material. The membranes were washed with THF for 10 min to remove any possible contaminants. When the membrane was found to be completely dry, 3 μL of the cocktail solution was deposited on it (see below cocktail preparation). The impregnation of the cocktail was found to be instantaneous; however, the membrane was let in the Petri Dish for ca. 10 min to ensure a homogenous and reproducible impregnation of the pores. Afterwards, the membrane was conditioned in the buffer solution for 40 min. Finally, the membrane was mounted in the electrode body. The inner compartment was filled with 10 mM of primary analyte whereas the outer solution contains the buffered solution mentioned above.

The used cocktail for the impregnation of PP membranes contains all the reagents mentioned before except PVC. K1:15 mmol kg⁻¹ of Ionophore I, 5 mmol kg⁻¹ of NaTFPB, 20 mmol kg⁻¹ of ETH500, 190 mg of DOS and 1 mL THF. THF was only used to enhance the solubility of the solid compounds into the plasticizers. It is important to remark that THF have to be evaporated before casting the membranes.

Calcium PP membranes were optimized in order to increase the upper limit of detection up to 3 mM which is the amount found in undiluted blood. Therefore, different membranes varying the ionophore concentration were evaluated. PP-Ca₁ (15:5:90 which means 15 mmol kg⁻¹ of lonophore, 5 mmol kg⁻¹ of NaTFPB, 90 mmol kg⁻¹ of ETH500 and o-NPOE up to 100 mg total cocktail amount), PP-Ca₂ (30:5:90), PP-Ca₃ (50:5:90), PP-Ca₄ (70:5:90), PP-Ca₅ (90:5:90), PP-Ca₆ (120:5:90), PP-Ca₇ (150:5:90), PP-Ca₈ (180:5:90).

1. A permselective membrane for reversible detection of an analyte ion in a sample, said membrane comprising
a lipophilic reagent for the detection of said analyte ion by dynamic electrochemistry, wherein said lipophilic reagent is either an electrically neutral ionophore or an ion-exchanger, and
a lipophilic ion, wherein said lipophilic ion is either of the opposite electric charge sign as said analyte ion in case an electrically neutral ionophore is present in the permselective membrane or of the same electric charge sign as said analyte ion in case an ion-exchanger is present in the permselective membrane,
wherein said lipophilic reagent is in excess of said lipophilic ion and wherein said lipophilic reagent is selective for said analyte ion.

2. The permselective membrane according to claim 1, wherein said dynamic electrochemistry is chronopotentiometry, amperometry, coulometry and similar methods.

3. The permselective membrane according to claim 1, wherein said lipophilic reagent is in a 100% molar excess over said lipophilic ion.

4. The permselective membrane according to claim 1, wherein said electrically neutral ionophore is selected from the group comprising (−)-(R,R)—N,N′-Bis-[11-(ethoxycarbonyl)undecyl]-N,N′,4,5-tetramethyl-3,6-dioxaoctane-diamide, Diethyl N,N′-[(4R,5R)-4,5-dimethyl-1,8-dioxo-3,6-dioxaoctamethylene]bis(12-methylaminododecanoate) (ETH 1001), N,N,N′,N′-Tetra[cyclohexyl]diglycolic acid diamide, N,N,N′,N′-Tetracyclohexyl-3-oxapentanediamide (ETH 129), N,N-Dicyclohexyl-N′,N′-dioctadecyl-3-oxapentanediamide, N,N-Dicyclohexyl-N′,N′-dioctadecyl-diglycolic diamide (ETH 5234), 10,19-Bis[(octadecylcarbamoyl)methoxyacetyl]-1,4,7,13,16-pentaoxa-10,19-diazacycloheneicosane (K23E1), N,N-Dicyclohexyl-N′-phenyl-N′-3-(2-propenoyl)-oxyphenyl-3-oxapentanediamide (AU-1).

5. The permselective membrane according to claim 1, wherein said ion-exchanger is selected from the group comprising dinonylnaphthalene sulfonate, tetraphenylborate derivatives, and other selective compounds for analyte ion.

6. The permselective membrane according to claim 1, wherein said lipophilic ion is selected from the group comprising tetradodecylammonium, dimethyldioctadecylammonium, tetraphenylphosphonium, tetraheptylammonium, and tridodecylmethylammonium.

7. The permselective membrane according to claim 1, wherein said analyte ion is monoion or polyion.

8. The permselective membrane according to claim 7, wherein said monoion is calcium, hydrogen ion, hydroxide ion, magnesium, nitrite, fluoride, or phosphate.

9. The permselective membrane according to claim 7, wherein said polyion is protamine, heparine humic acids, carrageenans, deoxyribonucleic acids, ribonucleic acids and other polyionic macromolecules.

10. The permselective membrane according to claim 1, wherein said analyte ion is protamine, wherein said membrane comprising dinonylnaphthalene sulfonate and tetradodecylammonium, wherein dinonylnaphthalene sulfonate is in excess over tetradodecylammonium and wherein dinonylnaphthalene sulfonate is selective for protamine.

11-14. (canceled)

15. The permselective membrane according to claim 1, further comprising a plasticizer selected from the group consisting of 2-nitrophenyl octyl ether, dioctyl phthalate, dioctyl sebacate, dioctyl adipate, dibutyl sebacate, dibutyl phthalate, 1-decanol, 5-phenyl-1-pentanol, tetraundecyl benzhydrol 3,3′,4,4′-tetracarboxylate, benzyl ether, dioctylphenyl phosphonate, tris(2-ethylhexyl)phosphate, and 2-nitrophenyl octyl ether.

16. (canceled)

17. (canceled)

18. The permselective membrane according to claim 15, further comprising a microporous hydrophobic substrate selected from the group consisting of polyethylene, polypropylene, nylon, polyyinylidene fluoride, polycarbonate, polytetrafluoroethylene, acrylic copolymer, polyether sulfone, and copolymers and terpolymers thereof.

19. (canceled)

20. The permselective membrane according to claim 15, further comprising a polymeric film-forming material selected from the group consisting of polyvinyl chloride, polyurethane, cellulose triacetate, polyvinyl alcohol, silicone rubber, and copolymers thereof.

21-24. (canceled)

25. The membrane according to claim 18, wherein said plasticizer, said lipophilic reagent and said lipophilic ion comprise an admixture dispersed in said microporous hydrophobic substrate.

26. (canceled)

27. A permselective membrane electrode comprising:
a housing;
a reference solution contained within said housing;
an electrode operatively positioned within said housing so as to be in contact with said reference solution; and
the permselective membrane according to claim 1 disposed at one end of said housing and in contact with said reference solution within said housing, and being operatively positioned for contacting a sample solution external to said housing.

28. The permselective membrane electrode according to claim 27, wherein said reference solution is an electrolyte solution.

29-32. (canceled)

33. A method of measuring the concentration of an analyte ion in a sample solution, comprising:
providing a sample solution comprising said analyte ion and a background electrolyte;
contacting said sample solution with the permselective membrane electrode according to claim 27 for a sufficient period of time in order to allow spontaneous extraction of said analyte ion from the sample solution into the membrane;
contacting the sample with a reference electrode, wherein the permselective membrane electrode and the reference electrode are electrically connected;
applying an external current pulse of fixed duration to a circuit comprising the membrane electrode and the sample solution, thereby driving transport of said analyte ion from the sample solution into the membrane;
measuring a potentiometric response during the current pulse between the membrane electrode and the reference electrode; and
calculating the concentration of said analyte ion as a function of the potentiometric response.

34. The method according to claim 33, wherein the potentiometric response is measured over a period of time that is less than the total fixed duration of the external current pulse.

35. The method according to claim 33, wherein the fixed duration of the external current pulse is about 0.1 to about 2 seconds.

36. The method according to claim 33, wherein the potentiometric response is measured during the last about 100 milliseconds of the fixed duration of the external current pulse.

37. The method according to claim 33, further comprising applying an external electrode potential to the permselective membrane electrode and the reference electrode, thereby driving transport of analyte ion from the membrane.

38. The method according to claim 37, comprising continuously repeating said steps of applying the external current pulse, measuring the potentiometric response, calculating the concentration of analyte ion, and applying the external potential pulse.

39. The method according to claim 37, wherein the external electrode potential is a baseline potential.

40. The method according to claim 37, wherein the baseline potential is 0 V.

41. The method according to claim 37, wherein the external electrode potential is applied for a duration of time that is about 10 to about 20 times longer than the fixed duration of the external current pulse.

42. The method according to claim 33, wherein the circuit to which an external current pulse of fixed duration is applied further comprises the reference electrode.

43. The method according to claim 33, wherein the circuit to which an external current pulse of fixed duration is applied further comprises a counter electrode.

44. (canceled)

45. The method according to claim 33, wherein the reference electrode comprises a double junction electrode.

46. The method according to claim 33, wherein the sample solution comprises a biological component.

47. The method according to claim 46, wherein the sample solution is blood.

48. An electrochemical cell apparatus comprising:
i) a permselective membrane electrode according to claim 27;
ii) a reference electrode electrically connected to said membrane electrode; and
iii) an electrochemical instrument operatively connected to said membrane electrode and said reference electrode.

49. The electrochemical cell apparatus according to claim 48, further comprising a counter electrode electrically connected to said permselective membrane electrode.

50-54. (canceled)
